(19) United States
(12) Patent Application Publication
(10) Pub. No.: US 2024/0272603 A1
(43) Pub. Date: Aug. 15, 2024

(54) INFORMATION PROCESSING DEVICE, DEVICE FOR CONTROLLING MACHINE TOOL, AND NON-TRANSITORY COMPUTER-READABLE MEDIUM STORING A COMPUTER PROGRAM

(71) Applicant: FANUC CORPORATION, Yamanashi (JP)

(72) Inventor: Masashi YASUDA, Yamanashi (JP)

(73) Assignee: FANUC CORPORATION, Yamanashi (JP)

(21) Appl. No.: 18/567,387

(22) PCT Filed: Jun. 15, 2021
(86) PCT No.: PCT/JP2021/022673

§ 371 Date: Dec. 6, 2023

(51) Int. Cl. G05B 19/19

(52) U.S. Cl. CPC G05B 19/19; G05B 2219/49055; G05B 2219/49277

(57) ABSTRACT

The present invention provides a technique for reducing the workload of a machine tool user selecting one specific shaft to swing. Provided is a device 1 for controlling a machine tool that performs swinging cutting by causing only one specific shaft to swing, said device 1 for controlling a machine tool comprising: a swarf shredding determination unit 14 for determining, on the basis of tool data with which a tool shape can be recognized or relative positional relationship data pertaining to a workpiece and the tool, and movement data for causing the workpiece and the tool to move relative to each other, whether it is possible to shred swarf when performing swinging cutting by swinging only one specific shaft among a plurality of feed shafts; a swinging shaft selection unit 15 for selecting, on the basis of the result of determination by the swarf shredding determination unit 14, one specific shaft as a swinging shaft; and a swinging movement control unit 16 for controlling, on the basis of processing conditions, the one specific shaft selected by the swinging shaft selection unit 15 so as to cause the one specific shaft to swing.

### TECHNICAL FIELD

The present disclosure relates to an information processing device, a control device for a machine tool, and a computer program.

### BACKGROUND ART

Conventionally, it has been known that chips continuously caused in cutting of a workpiece with a cutting tool entangle in the cutting tool and cause machining defects or machine tool breakdown, for example. On this point, oscillation cutting in which the chips are shredded by cutting during relative oscillation of the cutting tool and the workpiece has been proposed. Normally, in oscillation cutting, the cutting tool and the workpiece oscillate relative to each other in a direction along a machining course.

For example, in a case where the workpiece has a tapered shape or an arc shape, there are a plurality of feed axes (e.g., Z-axis and X-axis) for feeding the cutting tool or the workpiece in the direction along the machining course. In this case, oscillation is made simultaneously along the plurality of axes, and for this reason, a burden on the machine tool is great. For this reason, a technique of reducing, by changing an oscillation direction from the direction along the machining course to a different direction at, e.g., a tapered portion of the workpiece, the burden on the machine tool while shredding the chips has been proposed (e.g., see Patent Document 1).

FIG. 31 is a view showing one example of conventional oscillation cutting. In this example, cutting is performed in a feed direction along the generatrix of the outer peripheral surface of a workpiece W rotating about a main axis S while a tool T is moving along a feed axis. In a case of cutting a tapered portion of the workpiece W with the tool T as shown in FIG. 31, the oscillation direction is changed, between a current pass and a previous pass, from the direction along the machining course to a different direction. For example, the oscillation direction along the machining course as indicated by a black arrow in FIG. 31 is changed to the oscillation direction which is the different direction in which an oscillation component in the Z-axis direction increases as an oscillation component in the X-axis direction decreases as indicated by a white arrow.

However, in the example shown in FIG. 31, by the change in the oscillation direction, the oscillation component in the Z-axis direction increases as the oscillation component in the X-axis direction decreases. Thus, the burden on the machine tool can be sufficiently reduced in a case where the inertia of the machine tool in the X-axis direction is extremely greater than the inertia in the Z-axis direction. That is, in the above-described conventional oscillation cutting, an effect of reducing the burden on the machine tool depends on the configuration of the machine tool.

On the other hand, a technique of not making oscillation along a plurality of feed axes, but making oscillation along only a specific axis has been proposed. In the case of oscillation along only the specific axis, control is facilitated, and therefore, a control cost can be reduced while the burden on the machine tool is reduced.
Patent Document 1: Japanese Patent No. 6763917

### DISCLOSURE OF THE INVENTION

### Problems to be Solved by the Invention

In the case of oscillation along only the specific axis, the availability of chip shredding varies according to an axis along which oscillation is made. However, in the conventional technique, it cannot be determined along which one of the axes oscillation is made, and the axis along which oscillation is made is determined on an empirical basis by a machine tool user. This leads to a great work burden on the user.

For this reason, there has been a demand for a technique of reducing the burden on the machine tool user due to a process of selecting the specific axis along which oscillation is made.

### Means for Solving the Problems

A first aspect of the present disclosure is an information processing device including a chip shredding determination unit that determines, based on tool data from which a tool shape is recognizable or relative positional relationship data on a workpiece and a tool and movement data on relative movement of the workpiece and the tool, whether or not chips are shreddable by oscillation cutting by oscillation along only a specific axis of a plurality of feed axes, and an output unit that outputs a determination result of the chip shredding determination unit.

A second aspect of the present disclosure is a control device for a machine tool for performing oscillation cutting by oscillation along only a specific axis, the control device including a chip shredding determination unit that determines, based on tool data from which a tool shape is recognizable or relative positional relationship data on a workpiece and a tool and movement data on relative movement of the workpiece and the tool, whether or not chips are shreddable by oscillation cutting by oscillation along only a specific axis of a plurality of feed axes, an oscillation axis selection unit that selects, based on a determination result of the chip shredding determination unit, the specific axis as an oscillation axis, and an oscillation control unit that performs a control of making oscillation along the specific axis selected by the oscillation axis selection unit.

A third aspect of the present disclosure is a computer program causing a computer to execute a chip shredding determination step of determining, based on tool data from which a tool shape is recognizable or relative positional relationship data on a workpiece and a tool and movement data on relative movement of the workpiece and the tool, whether or not chips are shreddable by oscillation cutting by oscillation along only a specific axis of a plurality of feed axes, and an output step of outputting a determination result of the chip shredding determination step.

### Effects of the Invention

According to the present disclosure, the burden on the machine tool user due to the process of selecting the specific axis along which oscillation is made can be reduced.

### BRIEF DESCRIPTION OF THE DRAWINGS

FIG. 1 is a diagram showing a control device for a machine tool according to an embodiment of the present disclosure;

FIG. 2 is a view showing movement directions 1 to 8 of a tool;

FIG. 3 is a view showing blade edge directions A to H of the tool;

FIG. 4 is a view showing the tool in the blade edge direction C;

FIG. 5 is a view showing the tool in the blade edge direction H;

FIG. 6 is a view showing relative positional relationship data on a workpiece and the tool;

FIG. 7 is a view showing outer diameter machining for the workpiece;

FIG. 8 is a view showing inner diameter machining for the workpiece;

FIG. 9 is a view showing cutting in the case of the movement direction 2 of the tool;

FIG. 10 is a view showing cutting in the case of the movement direction 3 of the tool;

FIG. 11 is a view showing cutting in the case of the blade edge direction C and movement direction 2 of the tool;

FIG. 12 is a view showing Z-axis oscillation or X-axis oscillation in cutting of FIG. 11;

FIG. 13 is a view showing cutting in the case of the blade edge direction H and movement direction 3 of the tool;

FIG. 14 is a view showing Z-axis oscillation or X-axis oscillation in cutting of FIG. 13;

FIG. 15 is a view showing a state of selecting a chip-shreddable oscillation axis based on the blade edge direction and movement direction of the tool;

FIG. 16 is a view showing a state of stopping, based on the blade edge direction and movement direction of the tool, oscillation in a case where there is no chip-shreddable oscillation axis;

FIG. 17 is a view showing the outer diameter machining in a case where a tool shape is unknown;

FIG. 18 is a view showing the inner diameter machining in a case where the tool shape is unknown;

FIG. 19 is a view showing the outer diameter machining in the case of the movement direction 2 of the tool;

FIG. 20 is a view showing the inner diameter machining in the case of the movement direction 3 of the tool;

FIG. 21 is a view showing Z-axis oscillation or X-axis oscillation in a case where the blade edge direction of the tool is D when the tool shape (blade edge direction) is unknown in the outer diameter machining in the movement direction 2 of the tool;

FIG. 22 is a view showing Z-axis oscillation or X-axis oscillation in a case where the blade edge direction of the tool is H when the tool shape (blade edge direction) is unknown in the outer diameter machining in the movement direction 2 of the tool;

FIG. 23 is a view showing Z-axis oscillation or X-axis oscillation in a case where the blade edge direction of the tool is B when the tool shape (blade edge direction) is unknown in the outer diameter machining in the movement direction 2 of the tool;

FIG. 24 is a view showing Z-axis oscillation or X-axis oscillation in a case where the blade edge direction of the tool is G when the tool shape (blade edge direction) is unknown in the outer diameter machining in the movement direction 2 of the tool;

FIG. 25 is a view showing Z-axis oscillation or X-axis oscillation in a case where the blade edge direction of the tool is C when the tool shape (blade edge direction) is unknown in the outer diameter machining in the movement direction 2 of the tool;

FIG. 26 is a view showing Z-axis oscillation or X-axis oscillation in a case where the blade edge direction of the tool is C when the tool shape (blade edge direction) is unknown in the inner diameter machining in the movement direction 3 of the tool;

FIG. 27 is a view showing Z-axis oscillation or X-axis oscillation in a case where the blade edge direction of the tool is G when the tool shape (blade edge direction) is unknown in the inner diameter machining in the movement direction 3 of the tool;

FIG. 28 is a view showing Z-axis oscillation or X-axis oscillation in a case where the blade edge direction of the tool is B when the tool shape (blade edge direction) is unknown in the inner diameter machining in the movement direction 3 of the tool;

FIG. 29 is a view showing Z-axis oscillation or X-axis oscillation in a case where the blade edge direction of the tool is F when the tool shape (blade edge direction) is unknown in the inner diameter machining in the movement direction 3 of the tool;

FIG. 30 is a view showing Z-axis oscillation or X-axis oscillation in a case where the blade edge direction of the tool is A when the tool shape (blade edge direction) is unknown in the inner diameter machining in the movement direction 3 of the tool; and

FIG. 31 is a view showing one example of conventional oscillation cutting.

### PREFERRED MODE FOR CARRYING OUT THE INVENTION

Hereinafter, an embodiment of the present disclosure will be described in detail with reference to the drawings.

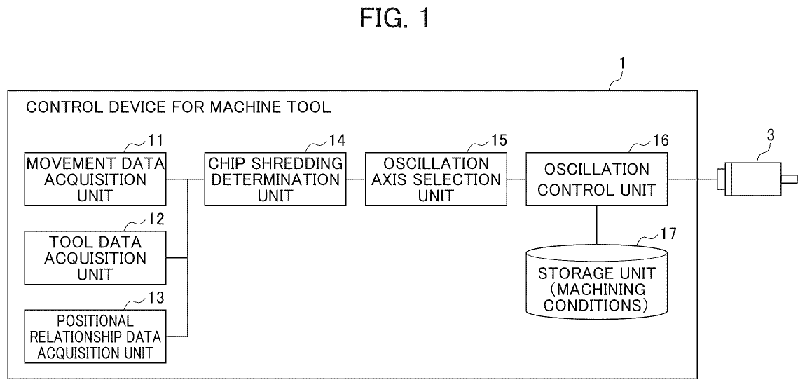

FIG. 1 is a diagram showing a control device 1 for a machine tool according to the present embodiment. The control device 1 for the machine tool according to the present embodiment controls a cutting tool (hereinafter, tool) to cut a workpiece by operating at least one main axis for rotating the tool and the workpiece relative to each other and at least one feed axis for moving the tool relative to the workpiece. Note that for the sake of convenience, FIG. 1 only shows a motor 3 that drives one feed axis.

The control device 1 for the machine tool according to the present embodiment operates the main axis and the feed axis, thereby performing oscillation cutting. That is, the control device 1 for the machine tool oscillates the tool and the workpiece relative to each other while rotating the tool and the workpiece relative to each other, thereby performing cutting. A tool course which is a tool path is set such that a current course partially overlaps with a previous course and a portion machined on the previous course is included in the current course. Thus, by air cutting in which a blade edge of the tool is apart from a surface of the workpiece, chips continuously caused due to cutting are reliably shredded.

Note that in oscillation cutting performed in the present embodiment, the shape of the workpiece is not limited. That is, the present invention is applicable not only to a case where a plurality of feed axes (Z-axis and X-axis) is necessary because the workpiece has a tapered portion or an arc portion at a machining surface, but also to a case where a specific feed axis (Z-axis) is enough because the workpiece has a circular columnar shape or a cylindrical shape.

The control device 1 for the machine tool is configured, for example, using a computer including a memory such as a read only memory (ROM) or a random access memory (RAM), a control processing unit (CPU), and a communication control unit, these components of the computer being connected to each other via a bus. As shown in FIG. 1, the control device 1 for the machine tool includes a movement data acquisition unit 11, a tool data acquisition unit 12, a positional relationship data acquisition unit 13, a chip shredding determination unit 14, an oscillation axis selection unit 15, an oscillation control unit 16, and a storage unit 17, and the function and operation of each unit may be implemented by cooperation of the CPU and memory installed in the above-described computer and a control program stored in the memory.

A higher-level computer (not shown) such as a computer numerical controller (CNC) or a programmable logic controller (PLC) is connected to the control device 1 for the machine tool. From such a higher-level computer, not only a machining program but also machining conditions such as a rotation speed and a feed speed and oscillation conditions such as an oscillation amplitude and an oscillation frequency are input to the control device 1 for the machine tool.

The movement data acquisition unit 11 acquires movement data on relative movement of the workpiece and the tool. Specifically, the movement data acquisition unit 11 acquires the movement data from the machining program input from the above-described higher-level computer. Note that a movement data acquisition source is not limited to the machining program as long as the movement data, such as the machining conditions, to be input to the control device 1 for the machine tool can be acquired. From the movement data, a tool movement direction can be acquired.

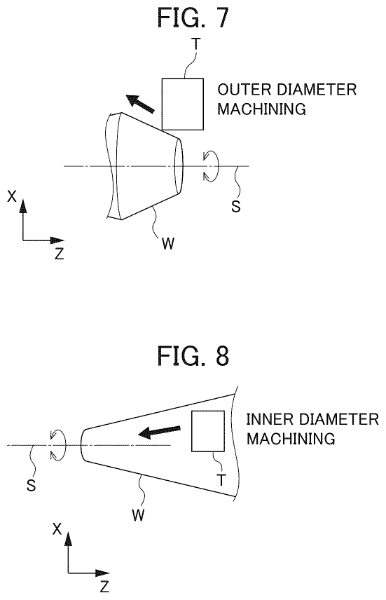

Here, in the present embodiment, cutting is performed while a tool T is being moved along the feed axis relative to a workpiece W rotating about a main axis S, as shown in each of FIG. 7 and figures subsequent thereto (described later). The center axis of the workpiece W is a Z-axis, and a direction perpendicular to the Z-axis is an X-axis. Note that the present embodiment is not limited to above and it may be configured such that cutting is performed while the tool T is rotating about the center axis of the workpiece W and the workpiece W is being moved in a feed direction relative to the tool T.

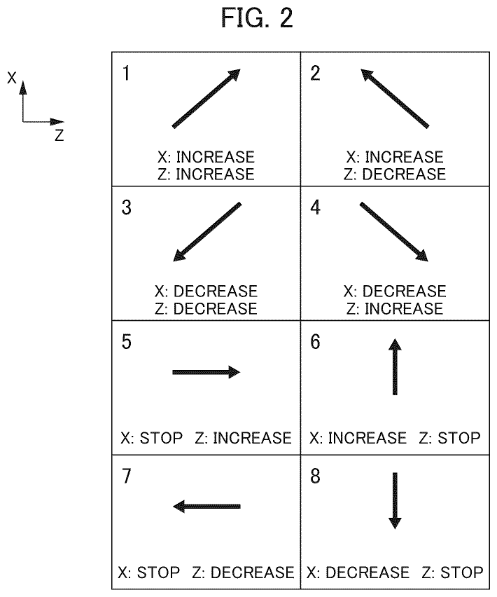

FIG. 2 is a view showing movement directions 1 to 8 of the tool T. As shown in FIG. 2, there are eight movement directions of the tool T. Specifically, the movement direction of the tool T is categorized into the eight movement directions 1 to 8 according to a combination of an increase/decrease in an X-axis coordinate value and an increase/decrease in a Z-axis coordinate value. The movement direction 1 is a direction in which both the X-axis coordinate value and the Z-axis coordinate value increase, the movement direction 2 is a direction in which the X-axis coordinate value increases and the Z-axis coordinate value decreases, the movement direction 3 is a direction in which both the X-axis coordinate value and the Z-axis coordinate value decrease, and the movement direction 4 is a direction in which the X-axis coordinate value decreases and the Z-axis coordinate value increases. Moreover, the movement direction 5 is a direction in which the X-axis coordinate value is constant (stop) and the Z-axis coordinate value increases, the movement direction 6 is a direction in which the X-axis coordinate value increases and the Z-axis coordinate value is constant (stop), the movement direction 7 is a direction in which the X-axis coordinate value is constant (stop) and the Z-axis coordinate value decreases, and the movement direction 8 is a direction in which the X-axis coordinate value decreases and the Z-axis coordinate value is constant (stop). As described above, the tool T moves in any of the movement directions 1 to 8.

Referring back to FIG. 1, the tool data acquisition unit 12 acquires tool data from which a tool shape is recognizable. Specifically, the tool data acquisition unit 12 acquires the tool data from the machining program input from the above-described higher-level computer, for example. The tool data includes at least information on the blade edge direction of the tool T, and for example, includes the cutting edge angle of the tool T. Note that the cutting edge angle of the tool T is an angle between the Z-axis direction which is the center axis direction of the workpiece W and the flank surface of the tool T, and the flank surface means a workpiece-W-side surface of the blade edge of the tool T in a machining direction. The cutting edge angle is set to a desired angle in advance for each of a plurality of tools T.

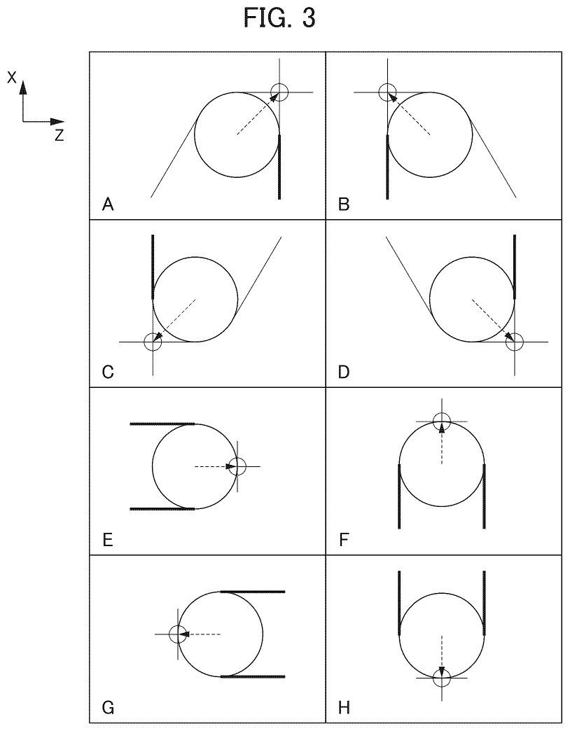

FIG. 3 is a view showing blade edge directions A to H of the tool T. As shown in FIG. 3, there are eight blade edge directions of the tool T. Specifically, the blade edge directions A to H of the tool T each correspond to the movement directions 1 to 8 of the tool T. That is, the blade edge direction A of the tool T corresponds to the movement direction 1, the blade edge direction B corresponds to the movement direction 2, the blade edge direction C corresponds to the movement direction 3, and the blade edge direction D corresponds to the movement direction 4. Moreover, the blade edge direction E of the tool T corresponds to the movement direction 5, the blade edge direction F corresponds to the movement direction 6, the blade edge direction G corresponds to the movement direction 7, and the blade edge direction H corresponds to the movement direction 8. As described above, the blade edge of the tool T points in any of the blade edge directions A to H.

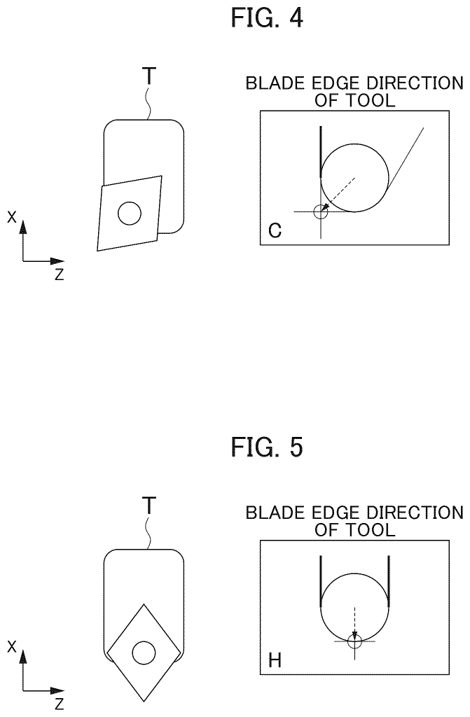

FIG. 4 is a view showing the tool T in the blade edge direction C. Moreover, FIG. 5 shows the tool T in the blade edge direction H. As shown in these figures, the eight blade edge directions are settable for the tool T, and the blade edge direction of the tool T greatly influences the availability of chip shredding in oscillation cutting. Thus, the blade edge direction of the tool T is used for determination on the availability of chip shredding by the later-described chip shredding determination unit 14.

Referring back to FIG. 1, the positional relationship data acquisition unit 13 acquires relative positional relationship data on the workpiece W and the tool T. Specifically, the positional relationship data acquisition unit 13 acquires the positional relationship data from the machining program input from the above-described higher-level computer, for example. From the positional relationship data, information on whether machining is outer diameter machining or inner diameter machining can be acquired.

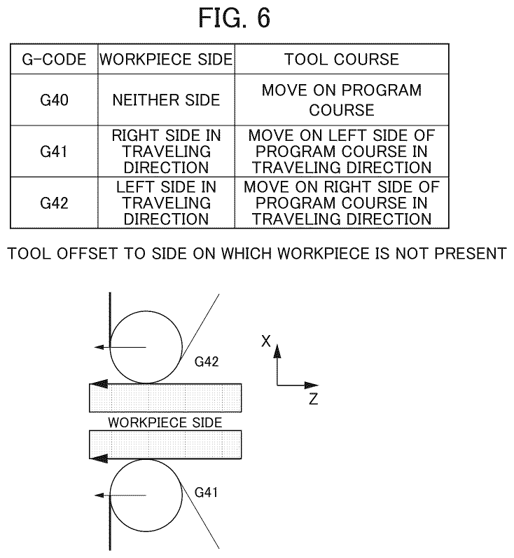

FIG. 6 is a table showing the relative positional relationship data on the workpiece W and the tool T. G40, G41, and G42 shown in FIG. 6 are G-codes regarding tool diameter compensation, and from these G-codes, the relative positional relationship between the workpiece W and the tool T can be acquired. Specifically, G40 is a G-code for cancelling tool diameter compensation, and in this case, the tool T moves on a program course. On the other hand, G41 is a G-code for tool diameter compensation left, and in this case, offset compensation from the program course to a side on which the workpiece W is not present is made to the tool T by a command value as shown in FIG. 6, and accordingly, the tool T moves on the left side in a traveling direction and the workpiece W is positioned on the right side in the traveling direction. G42 is a G-code for tool diameter compensation right, and in this case, offset compensation from the program course to a side on which the workpiece W is not present is made to the tool T by a command value, and accordingly, the tool T moves on the right side in the traveling direction and the workpiece W is positioned on the left side in the traveling direction.

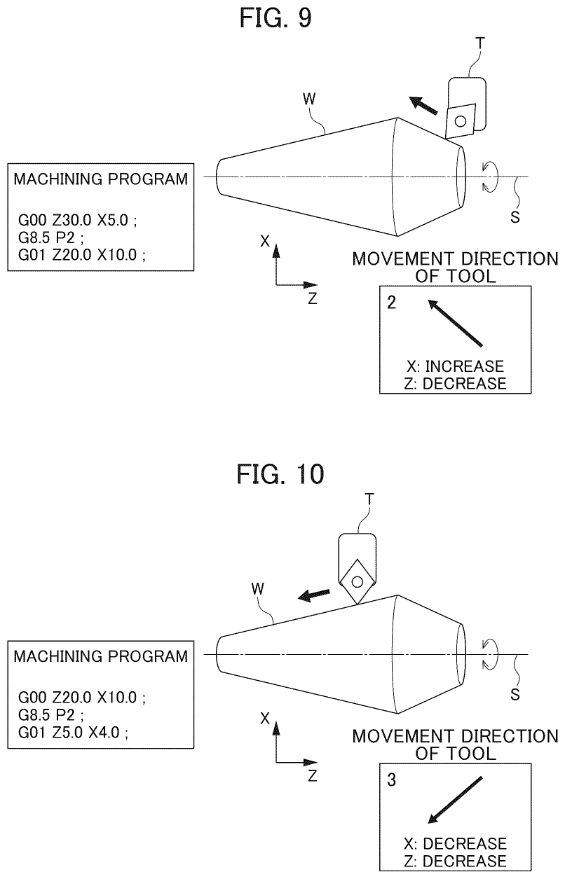

The positional relationship data acquisition unit 13 of the present embodiment acquires the relative positional relationship data on the workpiece W and the tool T from the G-code in the machining program input to the control device 1 for the machine tool, for example. Specifically, in a case where the G-code is G41, the positional relationship data acquisition unit 13 acquires, as the relative positional relationship between the workpiece W and the tool T, positional relationship data on the inner diameter machining as shown in FIG. 8. In a case where the G-code is G42, the positional relationship data acquisition unit 13 acquires, as the relative positional relationship between the workpiece W and the tool T, positional relationship data on the outer diameter machining as shown in FIG. 9.

Referring back to FIG. 1, the chip shredding determination unit 14 determines, based on the above-described tool data and the above-described movement data, whether or not the continuously-caused chips are shreddable in oscillation cutting by oscillation along only the specific axis of the plurality of feed axes. Alternatively, the chip shredding determination unit 14 determines, based on the above-described positional relationship data and the above-described movement data, whether or not the continuously-caused chips are shreddable in oscillation cutting by oscillation along only the specific axis of the plurality of feed axes.

Here, determination on the availability of chip shredding is influenced by the oscillation conditions such as the oscillation amplitude and the oscillation frequency. Thus, in determination on the availability of chip shredding by the chip shredding determination unit 14, it is determined whether or not the chips are shreddable if the oscillation amplitude is an arbitrary level in a case where oscillation is made along the specific axis, for example. That is, for example, in a case where the chips are shreddable with the arbitrary oscillation amplitude, it is determined that the chips are shreddable. In a case where no oscillation amplitude with which the chips are shreddable can be found even by changing the oscillation amplitude, it is determined that the chips are not shreddable. Such determination on the availability of chip shredding by the chip shredding determination unit 14 will be described later in detail.

The oscillation axis selection unit 15 selects, as an oscillation axis, the specific axis based on a determination result of the chip shredding determination unit 14. The chip shredding determination unit 14 can obtain the result of determination on the availability of chip shredding by oscillation cutting, and based on such a determination result, the oscillation axis selection unit 15 can automatically select the specific axis along which oscillation needs to be made.

Specifically, for example, the oscillation axis selection unit 15 selects, as the oscillation axis, a specific axis with the highest availability of chip shredding. The highest availability of chip shredding is not limited to a chip-shreddable probability of 100%, and also includes a probability of lower than 100%. Alternatively, the oscillation axis selection unit 15 may be configured not to select any axis as the oscillation axis in a case where there is no axis along which the chips are shreddable or a case where the availability of chip shredding is not 100%. Such selection of the oscillation axis by the oscillation axis selection unit 15 will be described later in detail.

The storage unit 17 stores the machining conditions for the workpiece W, etc. The machining conditions for the workpiece W include, for example, the relative rotation speeds of the workpiece W and the tool T about the center axis of the workpiece W, the relative feed speeds of the tool T and the workpiece W, and a feed axis position command. The storage unit 17 may store the machining program to be executed by the machine tool, and the CPU in the control device 1 for the machine tool may read, as the machining conditions, the rotation speeds and the feed speeds from the machining program and output the machining conditions to the oscillation control unit 16. For example, the storage unit 17 or a position command generation unit in the later-described oscillation control unit 16 may be provided in the above-described higher-level computer.

The oscillation control unit 16 performs, based on the machining conditions, a control of making oscillation along the specific axis selected by the oscillation axis selection unit 15. In order to control oscillation, the oscillation control unit 16 includes various functional units (not shown) such as the position command generation unit, an oscillation command generation unit, a superimposition command generation unit, a learning control unit, and a position/speed control unit.

The position command generation unit reads the machining conditions stored in the storage unit 17, and generates a position command as a movement command for the motor 3 based on the machining conditions. Specifically, the position command generation unit generates a position command (movement command) for each feed axis based on the relative rotation speeds of the workpiece W and the tool T about the center axis of the workpiece W and the relative feed speeds of the tool T and the workpiece W.

The oscillation command generation unit generates an oscillation command. The oscillation command generation unit may generate the oscillation command from the machining conditions and the oscillation conditions including an oscillation amplitude multiplying factor and an oscillation frequency multiplying factor, or may generate the oscillation command from the oscillation conditions including the oscillation amplitude and the oscillation frequency. Specifically, the oscillation command generation unit generates the oscillation command based on the oscillation conditions, such as the oscillation amplitude and the oscillation frequency, input from the higher-level computer and stored in the storage unit 17, for example.

The superimposition command generation unit calculates a position deviation which is a difference between the position command and a position feedback based on position detection on the feed axis by an encoder of the motor 3, and generates a superimposition command by superimposing the oscillation command generated by the oscillation command generation unit on the calculated position deviation. Alternatively, the oscillation command may be superimposed on the position command instead of the position deviation.

The learning control unit calculates a superimposition command compensation amount based on the superimposition command, and compensates the superimposition command by adding the calculated compensation amount to the superimposition command. The learning control unit has a memory, stores, in the memory, an oscillation phase and the compensation amount in association with each other in one or more cycles of oscillation, reads the superimposition command stored in the memory at a timing of being able to compensate a phase lag in oscillation according to the responsiveness of the motor 3, and outputs the superimposition command as the compensation amount. In a case where the oscillation phase associated with the compensation amount to be output is not stored in the memory, the compensation amount to be output may be calculated from a compensation amount associated with an oscillation phase close to the above-described oscillation phase. Generally, the position deviation for the oscillation command increases as the oscillation frequency increases. Thus, the learning control unit performs compensation so that followability to the cyclical oscillation command can be improved.

The position/speed control unit generates, based on the superimposition command after addition of the compensation amount, a torque command for the motor 3 that drives the feed axis, and controls the motor 3 according to the generated torque command. Accordingly, machining is performed while the tool T and the workpiece W are oscillating relative to each other.

Hereinafter, determination on the availability of chip shredding by the chip shredding determination unit 14 and selection of the oscillation axis by the oscillation axis selection unit 15 will be described in detail.

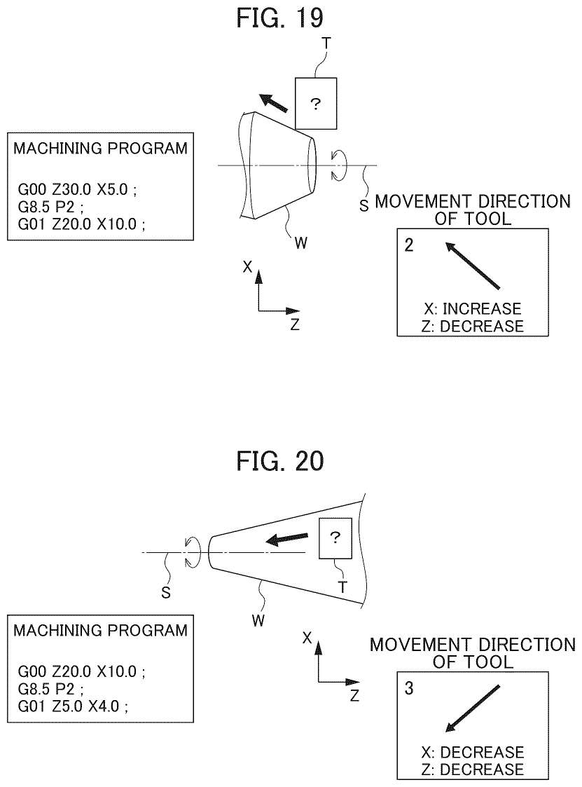

First, a case where the availability of chip shredding is determined based on the tool data and the movement data and the oscillation axis is selected based on the determination result will be described in detail with reference to FIGS. 9 to 16. As specific examples, examples of cutting in the case of the movement direction 2 of the tool T shown in FIG. 9 and the movement direction 3 of the tool T shown in FIG. 10 will be described. Note that in addition to the movement direction of the tool T, FIGS. 9 and 10 also show the machining program in each example (the same also applies to FIGS. 19 and 20 described later).

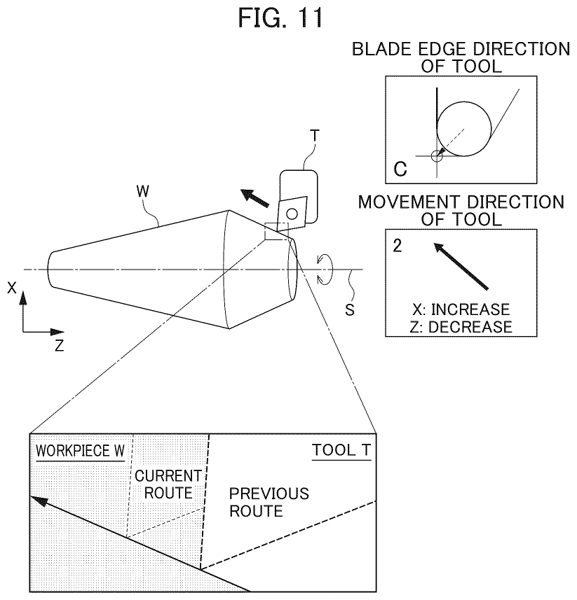

FIG. 11 is a view showing cutting in the case of the blade edge direction C and movement direction 2 of the tool T. That is, FIG. 11 shows a case where the blade edge direction of the tool T is C in cutting in the movement direction 2 shown in FIG. 9. An enlarged view shown in FIG. 11 shows the previous pass and current pass of the tool T when no oscillation is made.

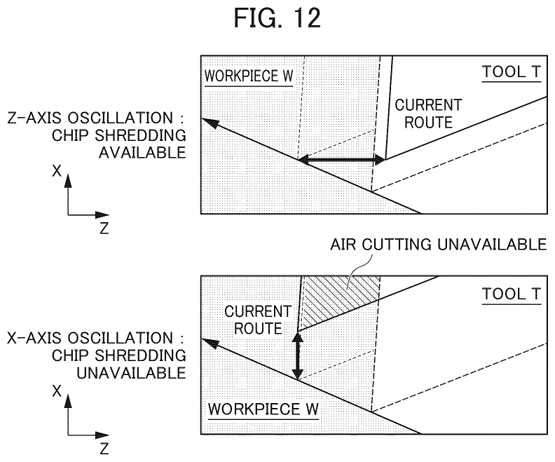

FIG. 12 is a view showing Z-axis oscillation or X-axis oscillation in cutting of FIG. 11. As shown in FIG. 12, in the case of oscillation in the Z-axis direction in cutting in the blade edge direction C and the movement direction 2, the current pass of the blade edge of the tool T is included in the previous pass, and the blade edge of the tool T can be moved to a position apart from the surface of the workpiece W. Thus, air cutting is available, and the chips are shreddable by air cutting. On the other hand, in the case of oscillation in the X-axis direction, the current pass of the blade edge of the tool T is not included in the previous pass, and the blade edge of the tool T cannot be moved only inside the workpiece W. Thus, air cutting is not available, and the chips are not shreddable by air cutting.

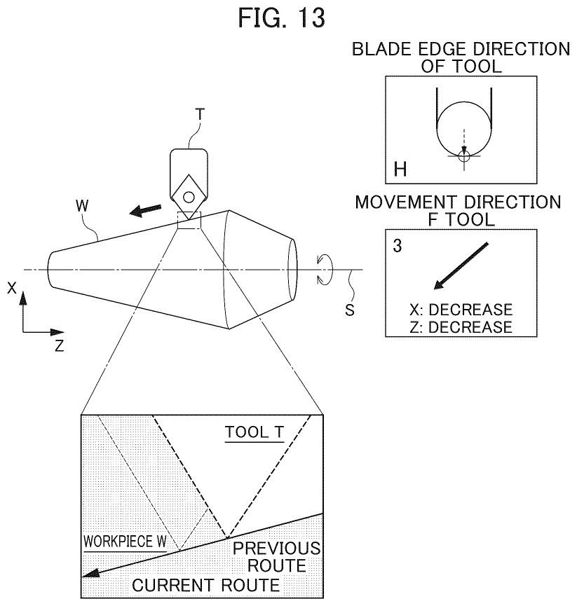

FIG. 13 is a view showing cutting in the case of the blade edge direction H and movement direction 3 of the tool T. That is, FIG. 13 shows a case where the blade edge direction of the tool T is H in cutting in the movement direction 3 shown in FIG. 10. An enlarged view shown in FIG. 13 shows the previous pass and current pass of the tool T when no oscillation is made.

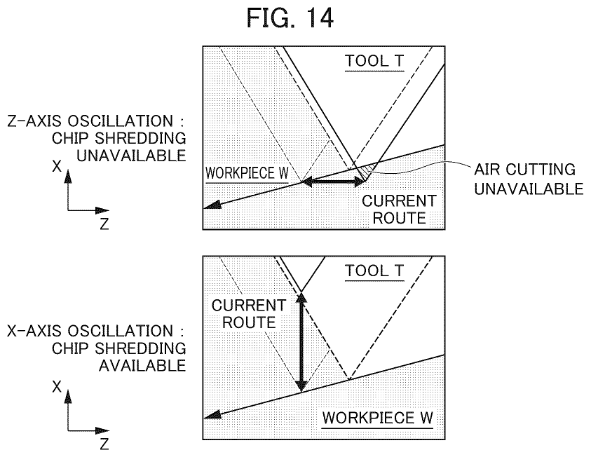

FIG. 14 is a view showing Z-axis oscillation or X-axis oscillation in cutting of FIG. 13. As shown in FIG. 14, in the case of oscillation in the Z-axis direction in cutting in the blade edge direction H and the movement direction 3, the current pass of the blade edge of the tool T is not included in the previous pass, and the blade edge of the tool T cannot be moved only inside the workpiece W. Thus, air cutting is not available, and the chips are not shreddable by air cutting. On the other hand, in the case of oscillation in the X-axis direction, the current pass of the blade edge of the tool T is included in the previous pass, and the blade edge of the tool T can be moved to a position apart from the surface of the workpiece W. Thus, air cutting is available, and the chips are shreddable by air cutting.

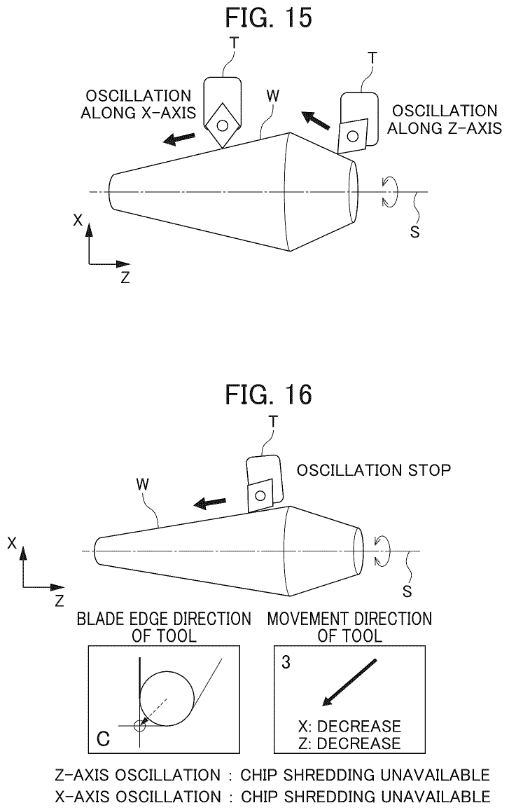

Thus, in the case of the blade edge direction C and the movement direction 2, the chip shredding determination unit 14 determines that the chips are shreddable by oscillation in the Z-axis direction, and based on such a determination result, the oscillation axis selection unit 15 selects the Z-axis as the oscillation axis. On the other hand, in the case of the blade edge direction H and the movement direction 3, the chip shredding determination unit 14 determines that the chips are shreddable by oscillation in the X-axis direction, and based on such a determination result, the oscillation axis selection unit 15 selects the X-axis as the oscillation axis. FIG. 15 is a view showing a state of selecting the chip-shreddable oscillation axis based on the blade edge direction and movement direction of the tool T.

FIG. 16 is a view showing a state of stopping oscillation in a case where it is determined, based on the blade edge direction and movement direction of the tool T, that there is no chip-shreddable oscillation axis. As shown in FIG. 16, in the case of the blade edge direction C and movement direction 3 of the tool T, the chips are not shreddable by any of oscillation in the Z-axis direction and oscillation in the X-axis direction. Thus, the oscillation axis selection unit 15 does not select any axis as the oscillation axis, as a result, stops oscillation.

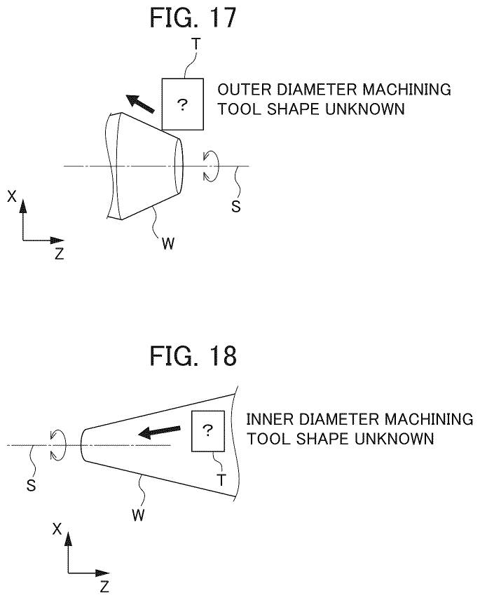

Next, a case where the availability of chip shredding is determined based on the relative positional relationship between the workpiece W and the tool T, i.e., the data on whether machining is the outer diameter machining or the inner diameter machining, and the movement data and the oscillation axis is selected based on the determination result will be described in detail with reference to FIGS. 17 to 30. As specific examples, an example where the movement direction of the tool T is 2 as shown in FIG. 19 when the tool shape (blade edge direction) is unknown in the outer diameter machining shown in FIG. 17 and an example where the movement direction of the tool T is 3 as shown in FIG. 20 when the tool shape (blade edge direction) is unknown in the inner diameter machining shown in FIG. 18 will be described.

Here, in the outer diameter machining in the movement direction 2 of the tool T, available blade edge directions of the tool T are five blade edge directions D, H, B, G, C among the blade edge directions A to H. That is, in the outer diameter machining in the movement direction 2 of the tool T, three blade edge directions A, E, F of the tool T are not available in terms of interference between the workpiece W and the tool T.

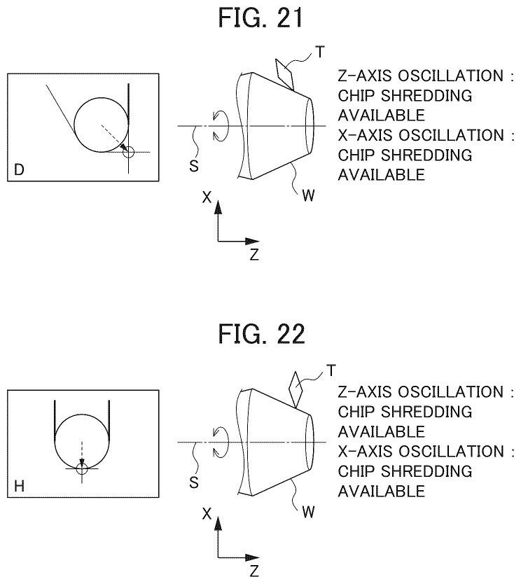

FIG. 21 is a view showing Z-axis oscillation or X-axis oscillation in a case where the blade edge direction of the tool is D when the tool shape (blade edge direction) is unknown in the outer diameter machining in the movement direction 2 of the tool T. In this case, the chips are shreddable by any of Z-axis oscillation and X-axis oscillation as shown in FIG. 21.

FIG. 22 is a view showing Z-axis oscillation or X-axis oscillation in a case where the blade edge direction of the tool is H when the tool shape (blade edge direction) is unknown in the outer diameter machining in the movement direction 2 of the tool T. In this case, the chips are shreddable by any of Z-axis oscillation and X-axis oscillation as shown in FIG. 22.

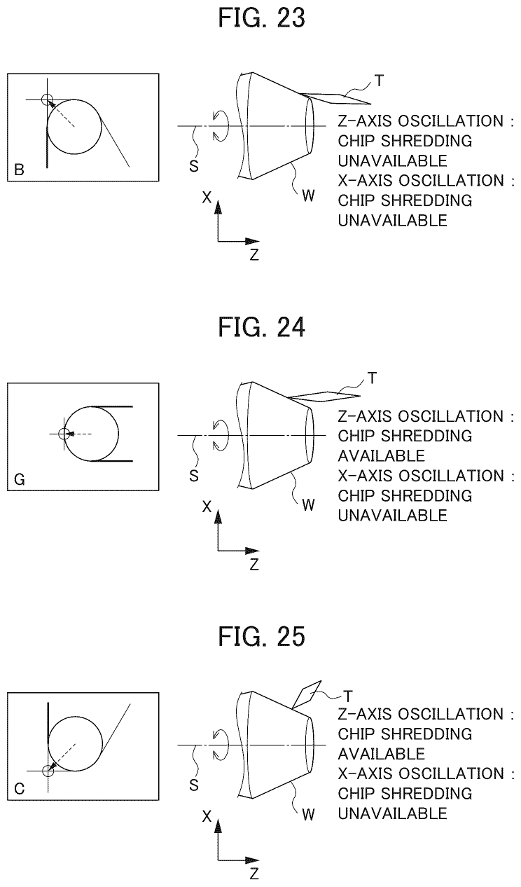

FIG. 23 is a view showing Z-axis oscillation or X-axis oscillation in a case where the blade edge direction of the tool is B when the tool shape (blade edge direction) is unknown in the outer diameter machining in the movement direction 2 of the tool T. In this case, the chips are not shreddable by any of Z-axis oscillation and X-axis oscillation as shown in FIG. 23.

FIG. 24 is a view showing Z-axis oscillation or X-axis oscillation in a case where the blade edge direction of the tool is G when the tool shape (blade edge direction) is unknown in the outer diameter machining in the movement direction 2 of the tool T. In this case, the chips are shreddable by Z-axis oscillation, but are not shreddable by X-axis oscillation as shown in FIG. 24.

FIG. 25 is a view showing Z-axis oscillation or X-axis oscillation in a case where the blade edge direction of the tool is C when the tool shape (blade edge direction) is unknown in the outer diameter machining in the movement direction 2 of the tool T. In this case, the chips are shreddable by Z-axis oscillation, but are not shreddable by X-axis oscillation as shown in FIG. 25.

The above-described results of determination on chip shredding as shown in FIGS. 21 to 25 show that in a case where the blade edge direction of the tool T is unknown in the outer diameter machining in the movement direction 2 of the tool T, the chips are also shreddable by Z-axis oscillation when the chips are shreddable by X-axis oscillation. That is, in this case, the availability (probability) of chip shredding is higher in Z-axis oscillation than in X-axis oscillation. Thus, in a case where the blade edge direction of the tool T is unknown in the outer diameter machining in the movement direction 2 of the tool T, the oscillation axis selection unit 15 selects, as the oscillation axis, the Z-axis with a higher availability of chip shredding.

In the inner diameter machining in the movement direction 3 of the tool T, available blade edge directions of the tool T are five blade edge directions C, G, B, F, A among the blade edge directions A to H. That is, in the inner diameter machining in the movement direction 3 of the tool T, three blade edge directions D, E, H of the tool T are not available in terms of interference between the workpiece W and the tool T.

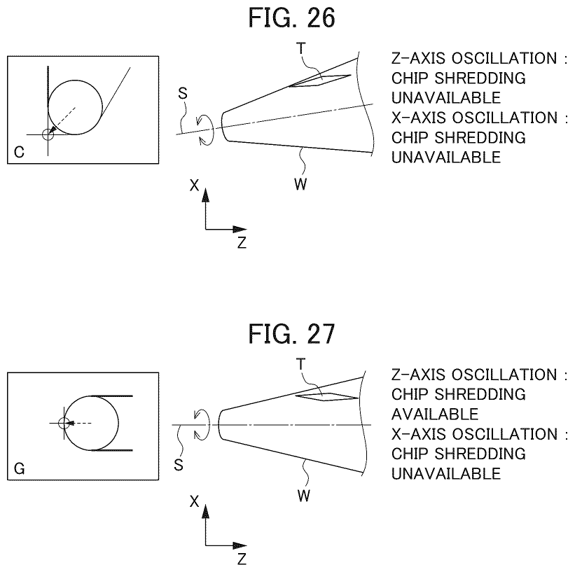

FIG. 26 is a view showing Z-axis oscillation or X-axis oscillation in a case where the blade edge direction of the tool is C when the tool shape (blade edge direction) is unknown in the inner diameter machining in the movement direction 3 of the tool T. In this case, the chips are not shreddable by any of Z-axis oscillation and X-axis oscillation as shown in FIG. 26.

FIG. 27 is a view showing Z-axis oscillation or X-axis oscillation in a case where the blade edge direction of the tool is G when the tool shape (blade edge direction) is unknown in the inner diameter machining in the movement direction 3 of the tool T. In this case, the chips are shreddable by Z-axis oscillation, but are not shreddable by X-axis oscillation as shown in FIG. 27.

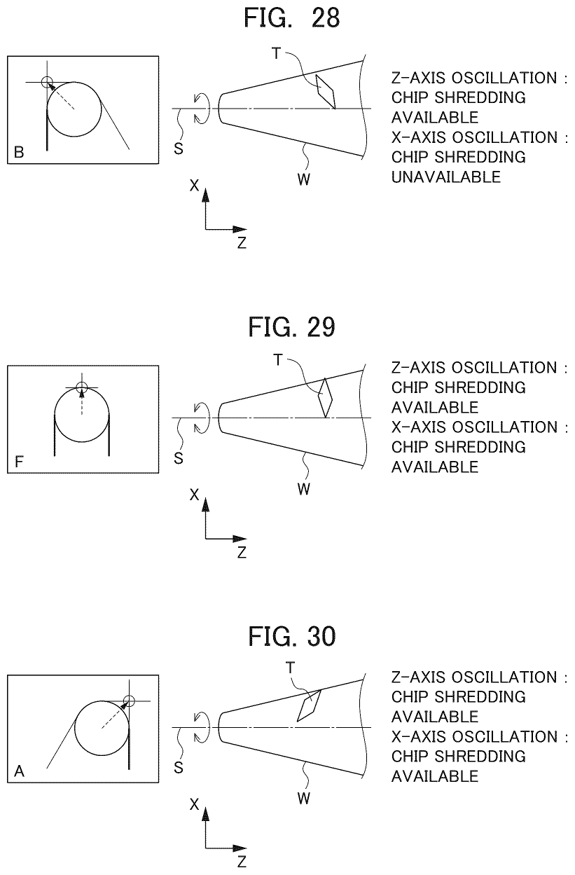

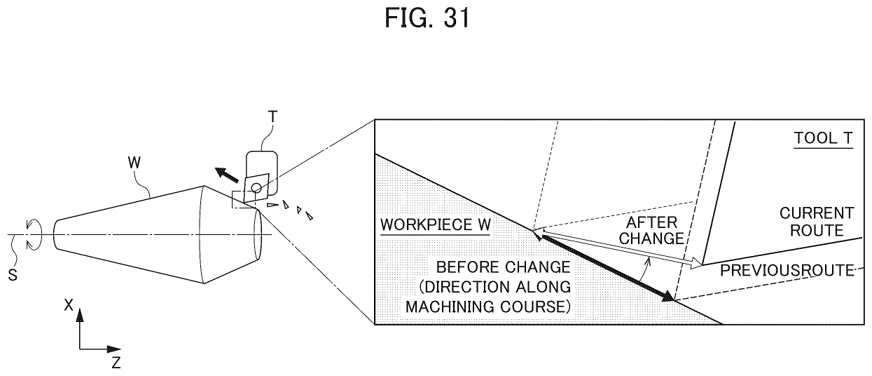

FIG. 28 is a view showing Z-axis oscillation or X-axis oscillation in a case where the blade edge direction of the tool is B when the tool shape (blade edge direction) is unknown in the inner diameter machining in the movement direction 3 of the tool T. In this case, the chips are shreddable by Z-axis oscillation, but are not shreddable by X-axis oscillation as shown in FIG. 28.

FIG. 29 is a view showing Z-axis oscillation or X-axis oscillation in a case where the blade edge direction of the tool is F when the tool shape (blade edge direction) is unknown in the inner diameter machining in the movement direction 3 of the tool T. In this case, the chips are shreddable by any of Z-axis oscillation and X-axis oscillation as shown in FIG. 29.

FIG. 30 is a view showing Z-axis oscillation or X-axis oscillation in a case where the blade edge direction of the tool is A when the tool shape (blade edge direction) is unknown in the inner diameter machining in the movement direction 3 of the tool T. In this case, the chips are shreddable by any of Z-axis oscillation and X-axis oscillation as shown in FIG. 30.

The above-described results of determination on chip shredding as shown in FIGS. 26 to 30 show that in a case where the blade edge direction of the tool T is unknown in the inner diameter machining in the movement direction 3 of the tool T, the chips are also shreddable by Z-axis oscillation when the chips are shreddable by X-axis oscillation. That is, in this case, the availability (probability) of chip shredding is higher in Z-axis oscillation than in X-axis oscillation. Thus, in a case where the blade edge direction of the tool T is unknown in the inner diameter machining in the movement direction 3 of the tool T, the oscillation axis selection unit 15 selects, as the oscillation axis, the Z-axis with a higher availability of chip shredding.

As described above, in oscillation cutting of the present embodiment, if the positional relationship between the tool T and the workpiece W and the movement direction of the tool T are known, one axis along which oscillation needs to be made can be selected similarly in any pattern.

Note that as clearly seen from the results of determination on chip shredding as shown in FIGS. 21 to 30, in a case where the shape of the workpiece W is, for example, a tapered shape or an arc shape and the movement direction of the tool T includes a plurality of axis directions (Z-axis direction and X-axis direction), the availability of chip shredding by oscillation in either one of the Z-axis direction or the X-axis direction is high, but less than 100%, and the availability of chip shredding by oscillation in the other axis direction is low and less than 100%. That is, even by oscillation in the Z-axis direction or the X-axis direction, the chips are not shreddable 100%. Thus, the oscillation axis selection unit 15 may include a selection stop unit that stops oscillation without selecting any oscillation axis. Thus, in this case, a user who wants to actively shred the chips can operate, by predetermined operation means, the oscillation axis selection unit 15 to select the axial direction with a higher availability of chip shredding from the Z-axis and the X-axis even when there is no guarantee of the chips being shreddable. On the other hand, a user who wants to avoid oscillation if the chips are not shreddable 100% can operate, by predetermined operation means, the oscillation axis selection unit 15 not to select the oscillation axis.

Note that in a case where the shape of the workpiece W is, for example, a circular columnar shape or a cylindrical shape and the movement direction of the tool T is one axis direction (Z-axis direction or X-axis direction), the availability of chip shredding by oscillation in either one of the Z-axis direction or the X-axis direction is 100%, and the availability of chip shredding by oscillation in the other axis direction is less than 100%. Thus, in this case, the oscillation axis selection unit 15 selects, as the oscillation axis, one axis in the same direction as the movement direction of the tool T. Specifically, one axis in the same direction as the movement direction is selected as the oscillation axis, and therefore, the availability of chip shredding is 100%.

According to the present embodiment, the following advantageous effects are provided.

In the present embodiment, the control device 1 for the machine tool for performing oscillation cutting by oscillation along only the specific axis includes the chip shredding determination unit 14 that determines, based on the tool data (blade edge direction of the tool T) from which the tool shape is recognizable or the relative positional relationship data on the workpiece W and the tool T and the movement data on relative movement of the workpiece W and the tool T, whether or not the chips are shreddable by oscillation cutting by oscillation along only the specific axis of the plurality of feed axes. Moreover, the control device 1 further includes the oscillation axis selection unit 15 that selects the specific axis as the oscillation axis based on the determination result of the chip shredding determination unit 14. In addition, the control device 1 further includes the oscillation control unit 16 that performs, based on the machining conditions, the control of making oscillation along the specific axis selected by the oscillation axis selection unit 15.

According to the present embodiment, the chip shredding determination unit 14 can determine the availability of chip shredding based on the tool data (blade edge direction of the tool) and the movement data or based on the relative positional relationship data on the workpiece W and the tool T and the movement data, and based on such a determination result, the oscillation axis selection unit 15 can automatically select the specific axis as the oscillation axis. Thus, according to the present embodiment, a burden on the machine tool user due to a process of selecting the specific axis along which oscillation is to be made can be reduced.

In the present embodiment, the oscillation axis selection unit 15 selects, as the oscillation axis, the specific axis with the highest availability of chip shredding. Thus, not only in a case where the availability of chip shredding is 100%, but also in a case where the availability of chip shredding is less than 100%, the oscillation axis selection unit 15 selects, as the oscillation axis, the specific axis with the highest availability of chip shredding so that the machine tool user who wants to actively perform oscillation cutting can automatically acquire the specific axis along which oscillation is to be made and the work burden can be reduced.

In the present embodiment, the oscillation axis selection unit 15 does not select any axis as the oscillation axis in a case where there is no axis along which the chips are shreddable or a case where the availability of chip shredding is not 100%. The oscillation control unit 16 performs a control of not making oscillation along any feed axis. Thus, for the user who wants to avoid oscillation not only in a case where there is no axis along which the chips are shreddable, but also in a case where the availability of chip shredding is not 100%, the oscillation axis selection unit 15 does not select the oscillation axis so that oscillation can be stopped.

Note that the present disclosure is not limited to the above-described aspects and changes and modifications are also included in the present disclosure without departing from a scope in which the object of the present disclosure can be achieved.

For example, in the above-described embodiment, the control device 1 for the machine tool includes both the tool data acquisition unit 12 and the positional relationship data acquisition unit 13, but the present invention is not limited thereto. The control device 1 may include only either one of the tool data acquisition unit 12 or the positional relationship data acquisition unit 13.

In the above-described embodiment, the present invention is applied to the control device 1 for the machine tool, but is not limited thereto. For example, the present invention is also applicable to, e.g., the above-described higher-level computer. That is, the present invention can provide an information processing device including the movement data acquisition unit 11, the tool data acquisition unit 12 and/or the positional relationship data acquisition unit 13, the chip shredding determination unit 14, and an output unit that outputs the determination results of the chip shredding determination unit 14. In this case, advantageous effects similar to those of the above-described embodiment can be provided, and the user can select the oscillation axis by oneself based on the chip shredding determination result because such a determination result is output and notified to the user. The information processing device may include the oscillation axis selection unit 15. The present invention is also applicable to a computer program causing a computer to execute a chip shredding determination step by the chip shredding determination unit 14, an output step by the output unit, and an oscillation axis selection step by the oscillation axis selection unit 15.

### EXPLANATION OF REFERENCE NUMERALS

1 Control Device for Machine Tool
11 Movement Data Acquisition Unit
12 Tool Data Acquisition Unit
13 Positional Relationship Data Acquisition Unit
14 Chip Shredding Determination Unit
15 Oscillation Axis Selection Unit
16 Oscillation Control Unit
17 Storage Unit
3 Motor
S Main Axis
T Tool
W Workpiece

1. An information processing device comprising:
a chip shredding determination unit that determines, based on tool data from which a tool shape is recognizable or relative positional relationship data on a workpiece and a tool and movement data on relative movement of the workpiece and the tool, whether or not a chip is shreddable by oscillation cutting by oscillation along only a specific axis of a plurality of feed axes; and
an output unit that outputs a determination result of the chip shredding determination unit.

2. The information processing device according to claim 1, further comprising:
an oscillation axis selection unit that selects, based on the determination result of the chip shredding determination unit, the specific axis as an oscillation axis,
wherein the output unit outputs a selection result of the oscillation axis selection unit.

3. The information processing device according to claim 2, wherein the oscillation axis selection unit selects, as the oscillation axis, a specific axis with a highest availability of chip shredding.

4. The information processing device according to claim 2, wherein the oscillation axis selection unit does not select any axis as the oscillation axis in a case where there is no axis along which the chip is shreddable or a case where an availability of chip shredding is not 100%.

5. A control device for a machine tool for performing oscillation cutting by oscillation along only a specific axis, comprising:
a chip shredding determination unit that determines, based on tool data from which a tool shape is recognizable or relative positional relationship data on a workpiece and a tool and movement data on relative movement of the workpiece and the tool, whether or not a chip is shreddable by oscillation cutting by oscillation along only a specific axis of a plurality of feed axes;
an oscillation axis selection unit that selects, based on a determination result of the chip shredding determination unit, the specific axis as an oscillation axis; and
an oscillation control unit that performs a control of making oscillation along the specific axis selected by the oscillation axis selection unit.

6. The control device for the machine tool according to claim 5, wherein the oscillation axis selection unit selects, as the oscillation axis, a specific axis with a highest availability of chip shredding.

7. The control device for the machine tool according to claim 5, wherein
the oscillation axis selection unit does not select any axis as the oscillation axis in a case where there is no axis along which the chip is shreddable or a case where an availability of chip shredding is not 100%, and
the oscillation control unit performs a control of not making oscillation along any feed axis.

8. A non-transitory computer-readable medium storing a computer program causing a computer to execute
a chip shredding determination step of determining, based on tool data from which a tool shape is recognizable or relative positional relationship data on a workpiece and a tool and movement data on relative movement of the workpiece and the tool, whether or not a chip is shreddable by oscillation cutting by oscillation along only a specific axis of a plurality of feed axes; and
an output step of outputting a determination result of the chip shredding determination step.

9. The non-transitory computer-readable medium storing the computer program according to claim 8, wherein
the computer further executes an oscillation axis selection step of selecting, based on the determination result of the chip shredding determination step, the specific axis as an oscillation axis, and
in the output step, a selection result of the oscillation axis selection step is output.
